(19) United States
(12) Patent Application Publication
(10) Pub. No.: US 2015/0046979 A1
(43) Pub. Date: Feb. 12, 2015

(54) Storage Detection Apparatus, System, and Method

(71) Applicant: Huawei Technologies Co., Ltd., Shenzhen (CN)

(72) Inventors: Hongzhong Wu, Chengdu (CN); Tianfu Jin, Xi'an (CN)

(21) Appl. No.: 14/523,417

(22) Filed: Oct. 24, 2014

Related U.S. Application Data
(63) Continuation of application No. PCT/CN2013/077538, filed on Jun. 20, 2013.

(51) Int. Cl. H04L 29/06; H04L 29/08

(52) U.S. Cl. CPC H04L 63/10; H04L 67/1097
USPC 726/3

(57) ABSTRACT

A storage detection apparatus is placed in an operating system in kernel mode; after file information is intercepted and a security level of file content is determined, file content of a high security level is redirected to a storage area of high storage security; the security level of the file content itself is determined and stored, which is transparent to a user, thereby implementing division of security levels for different documents generated by a same application.

### CROSS-REFERENCE TO RELATED APPLICATIONS

This application is a continuation of International Application No. PCT/CN2013/077538, filed on Jun. 20, 2013, which is hereby incorporated by reference in its entirety.

### TECHNICAL FIELD

Embodiments of the present invention relate to storage technologies, and in particular, to a storage detection apparatus, system, and method.

### BACKGROUND

In fields that require high information security, data needs to be stored in storage areas of different security performance according to different security levels, that is, tiered storage is performed according to security levels.

In the prior art, a security level of data to be stored is sometimes identified according to a type of an application. For example, the security level is identified according to internet protocol (IP) addresses of different servers. This identification manner is generally applicable to a scenario in which different applications correspond to different security levels, and different applications are stored on different servers. In this way, the IP addresses of the servers may be used to divide security levels of the data to be stored. If there are multiple applications on a same server and flow directions of service flows of different services are controlled using a transmission control protocol (TCP) or user datagram protocol (UDP) port using a firewall or a switch, it is generally practicable that applications of different security levels are distinguished by port numbers corresponding to different applications. For example, a high security level is preset for an application received from a specific port, and a low security level is preset for an application received from another specific port.

The inventor finds that identification of data security levels in the prior art is relatively rough, and is inapplicable to a scenario in which different service data is generated by a same application. For example, for documents of multiple levels in the same application, a solution to effectively identifying a document level is still not available currently.

### SUMMARY

Embodiments of the present invention provide a storage detection apparatus, system, and method to implement identification of a security level of a file.

According to a first aspect, an embodiment of the present invention provides a storage detection apparatus, where the apparatus is placed in an operating system in kernel mode and includes an intercepting unit, configured to intercept file information, where the intercepted file information includes file property information and file content, where the file property information includes file security information; a security level obtaining unit, configured to obtain a security level of the file content according to the file security information and based on a set security policy; and a redirecting unit, configured to, if the obtained security level reaches a preset importance level, redirect the file content to a first storage area for storing; if the obtained security level does not reach the preset importance level, redirect the file content to a second storage area for storing, where data storage security of the second storage area is lower than data storage security of the first storage area.

With reference to the first aspect, in a first possible manner provided in the embodiment of the present invention, the apparatus is placed in the operating system in kernel mode and separately communicates with an external interface driver, a file driver, and a volume directory management system in the operating system.

With reference to the first possible manner of the first aspect, in a second possible manner provided in the embodiment of the present invention, the file property information further includes file directory information and a file name; and the apparatus further includes a storing unit, configured to invoke the file driver in the operating system, and use the file driver to extract the file name and the file directory information from the obtained file information; and invoke the volume directory management system in the operating system, and use the volume directory management system to store the file name and the file directory information into a storage location specified in the file directory information.

According to a second aspect, an embodiment of the present invention provides a storage detection system, including a storage detection apparatus and an apparatus for inputting a security policy; where the storage detection apparatus is configured to intercept file information, where the intercepted file information includes file property information and file content, where the file property information includes file security information; receive the security policy, and obtain a security level of the file content according to the file security information and based on the security policy; and if the obtained security level reaches a preset importance level, redirect the file content to a first storage area for storing; if the obtained security level does not reach the preset importance level, redirect the file content to a second storage area for storing, where data storage security of the second storage area is lower than data storage security of the first storage area; and the security policy input apparatus is configured to, by providing a visualized application window for a user, receive the security policy input by the user, and send the received security policy to the storage detection apparatus.

With reference to the second aspect, in a first possible implementation manner, the storage detection system further includes an authentication apparatus, configured to authenticate permission of the user before the security policy input apparatus receives the security policy input by the user, and, after the authentication succeeds, start the security policy input apparatus; if the authentication fails, do not start the security policy input apparatus.

According to a third aspect, an embodiment of the present invention provides a storage detection method, where the method is applied in an operating system in kernel mode and includes intercepting file information, where the intercepted file information includes file property information and file content, where the file property information includes file security information; obtaining a security level of the file content according to the file security information and based on a set security policy; and if the obtained security level reaches a preset importance level, redirecting the file content to a first storage area for storing; if the obtained security level does not reach the preset importance level, redirecting the file content to a second storage area for storing, where data storage security of the second storage area is lower than data storage security of the first storage area.

With reference to the third aspect, in a first possible implementation manner, the intercepting file information includes invoking an external interface driver in the operating system, and intercepting the file information using the external interface driver.

With reference to the third aspect, in a second possible implementation manner, the file property information further includes file directory information and a file name; and the method further includes invoking a file driver in the operating system, and using the file driver to extract the file name and the file directory information from the obtained file information; and invoking a volume directory management system in the operating system, and using the volume directory management system to store the file name and the file directory information into a storage location specified in the file directory information.

With reference to the third aspect or the first manner of the third aspect or the second manner of the third aspect, in a third possible manner, the method further includes receiving the security policy, where the received security policy is used to determine the security level of the file content.

The storage detection apparatus provided in the embodiment of the present invention is placed in an operating system in kernel mode; after file information is intercepted and a security level of file content is determined, file content of a high security level is redirected to a storage area of high storage security; the security level of the file content itself is determined and stored, which is transparent to a user, thereby implementing division of security levels for different documents generated by a same application.

### BRIEF DESCRIPTION OF DRAWINGS

To describe the technical solutions in the embodiments of the present invention or in the prior art more clearly, the following briefly introduces the accompanying drawings required for describing the embodiments. The accompanying drawings in the following description show some embodiments of the present invention, and a person of ordinary skill in the art may still derive other drawings from these accompanying drawings without creative efforts.

FIG. 1 is a schematic structural diagram of a storage detection apparatus according to an embodiment of the present invention;

FIG. 2 is a diagram of an application scenario of a storage detection apparatus on which a Windows operating system is run according to an embodiment of the present invention;

FIG. 3 is a schematic structural diagram of a storage detection system according to an embodiment of the present invention;

FIG. 4 is a flowchart of a storage detection method according to an embodiment of the present invention; and

FIG. 5 is a schematic structural diagram of a storage detection apparatus according to an embodiment of the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. The described embodiments are a part rather than all of the embodiments of the present invention. All other embodiments obtained by a person of ordinary skill in the art based on the embodiments of the present invention without creative efforts shall fall within the protection scope of the present invention.

A storage detection apparatus provided in an embodiment of the present invention is placed in an operating system in kernel mode. For example, in the operating system in kernel mode, the storage detection apparatus separately communicates with an external interface driver, a file driver, and a volume directory management system in the operating system, and is connected to a local storing unit. In a practical application, the storage detection apparatus provided in the embodiment of the present invention implements that documents of different security levels are stored into different storage areas, where different storage areas have different data storage security, which is generally referred to as tiered storage. Storage security of a storage area denotes reliability and error tolerance performance of storing data in the storage area. Higher performance indicates higher data security. The storage detection apparatus provided in the embodiment of the present invention may be a piece of middleware placed in the operating system in kernel mode. The storage detection apparatus provided in the embodiment of the present invention may be placed together with the operating system on a gateway or placed on a device that requires tiered storage such as a server.

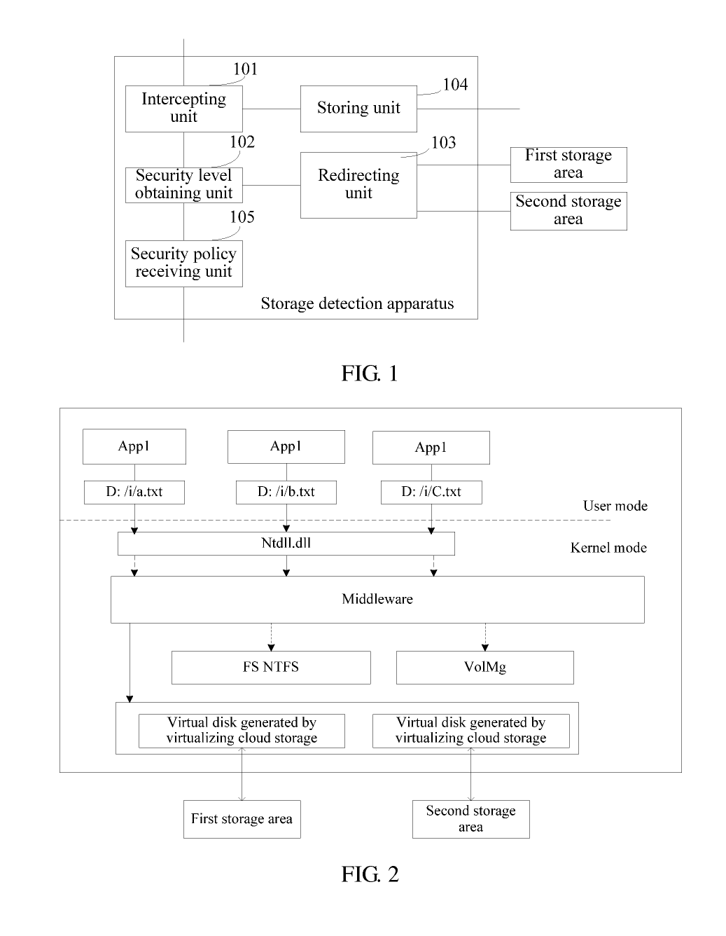

Referring to FIG. 1, a storage detection apparatus provided in an embodiment of the present invention includes an intercepting unit 101, a security level obtaining unit 102, and a redirecting unit 103.

The intercepting unit 101 is configured to intercept file information that needs to be stored, where the intercepted file information includes file property information and file content, where the file property information includes file security information and the like.

The intercepting unit 101 intercepts the file information using an external interface driver.

The file security information is information for determining a file security level. The information used as the file information for determining the file security level corresponds to a security policy preset by a user. For example, when the security policy preset by the user is to use a watermark that is set in a document as a basis for determining the file security level, the file security information includes function information of the set file watermark. When the security policy preset by the user is to use sensitive character information in the document as a basis for determining the file security level, the file security information includes the sensitive character information in the file. In specific implementation, the security policy is flexible, and is configured by the user according to actual conditions. Therefore, the file security information shall not be construed as one or two types of information, and may be flexibly defined by a person skilled in the art according to actual conditions.

The security level obtaining unit 102 is configured to obtain a security level of the file content according to the file security information and based on a set security policy.

As mentioned above, the security policy is a specific policy that is set by the user for determining the file security level. For example, the security policy is to determine, according to whether there is a watermark in a document, whether the document reaches an importance level, or the security policy is to determine, according to the sensitive character information included in the file, whether the file reaches an importance level. In conclusion, the user may set the specific security policy flexibly according to actual conditions, which is not limited by the embodiment of the present invention. If the security policy that is set by the user is to determine the importance level of the file according to the sensitive character information included in the file, the sensitive characters are preset by the user.

The redirecting unit 103 is configured to, if the obtained security level reaches a preset importance level, redirect the file content to a first storage area for storing; if the obtained security level does not reach the preset importance level, redirect the file content to a second storage area for storing, where data storage security of the second storage area is lower than data storage security of the first storage area.

In the embodiment of the present invention, a user may preset different security levels for documents. Correspondingly, an entire storage area is divided according to data storage security of storage areas. Higher data storage security of a storage area that stores data indicates securer data storage. Documents of different security levels are stored in different storage areas. For example, a security-hardened storage area serves as a first storage area. Compared with other storage areas, the first storage area provides higher data storage security. A storage area whose data storage security is lower than that of the first storage area is referred to as a second storage area. In a practical application, according to different data storage security, storage areas may be divided into multiple levels, and data storage security of a storage area corresponding to each level decreases progressively. The embodiment of the present invention is described using only the first storage area and the second storage area as examples.

After intercepting the file information and determining the file security information, the storage detection apparatus provided in the embodiment of the present invention performs redirected storage for the file content. In order not to change operation habits of the user, the redirection work is not perceivable by the user. Therefore, the file name, the directory information, and the like in the file information need to be stored according to a location specified by the user. The file property information further includes the file directory information and the file name; and therefore, the storage detection apparatus provided in the embodiment of the present invention further includes a storing unit 104, configured to invoke a file driver in an operating system, and use the file driver to extract the file name and the file directory information from the obtained file information; and invoke a volume directory management system in the operating system, and use the volume directory management system to store the file name and the file directory information into a storage location specified in the file directory information.

Using a file driver technology, the storage detection apparatus provided in the embodiment of the present invention uses a file driver to extract the file name and the file directory information by means of a file read/write protocol, and then uses the volume directory management system to store the file name and the file directory information in a specified disk directory. The storing disk directory is an address specified by the user in the file directory information. Therefore, for the user, the file is not redirected and is still stored in the disk directory specified by the user.

Optionally, the security policy preset by the storage detection apparatus provided in the embodiment of the present invention may be a default security policy that is set in a tiered storage, or may be set by the user flexibly according to actual requirements. Therefore, to support the storage work of the storage detection apparatus provided in the embodiment of the present invention, some application programs may be further provided so that a visualized application window is provided for the user. Using the visualized application window, the preset security policy input by the user is received, and the received security policy is sent to the storage detection apparatus. Therefore, the storage detection apparatus provided in the embodiment of the present invention may further include a security policy receiving unit 105, configured to receive the security policy input by the user, where the received security policy is provided for the security level obtaining unit 102 to determine a security level of the file content.

Referring to FIG. 2, the following describes working principles of a storage detection apparatus provided in an embodiment of the present invention using a Windows® operating system as an example.

An implementation form of the storage detection apparatus provided in the embodiment of the present invention may be a piece of middleware installed in an operating system in kernel mode and installed between an external interface driver and a file driver in the operating system. In a Windows system, the storage detection apparatus may be installed between an Ntdll.dll driver and a file system (FS) new technology file system (NTFS) driver in the kernel mode, and the middleware separately communicates with the external interface driver Ntdll.dll, the file driver FS NTFS, and a volume directory management system (VolMg) in the Windows operating system. It is assumed that a same application App1 generates an a.txt file, a b.txt file, and a c.txt file and a storage location specified by a user is directory i under drive D of a disk.

By invoking the Ntdll.dll driver, the middleware intercepts file information, and a security level obtaining unit determines a security level of the intercepted file information according to a security policy that is set in the middleware.

When the obtained security level reaches a preset importance level, a storage location of file content in file information is redirected to a first storage area that is security-hardened, which may be a security-hardened cloud storage 1 shown in the drawing; when the obtained security level does not reach the preset importance level, the file content is stored into an ordinarily security-hardened cloud storage 2 shown in the drawing.

If the file storage location specified by the user is directory i under drive D of the disk, for file property information such as a file name and file directory information intercepted by the middleware, a file system NTFS interface may be invoked, and the file system NTFS interface is used to extract the file name and the file directory information from the file information; and then a VolMg is invoked, and the VolMg is used to store the file name and the file directory information into the location specified by the user.

A security policy receiving unit of the middleware communicates with a security policy configuration controlling unit to receive the security policy sent by the security policy configuration controlling unit. By providing a visualized application window for the user, the security policy configuration controlling unit receives the security policy that is set by the user.

In addition, the security policy configuration controlling unit communicates with a storage authentication window. Before the user configures the security policy using the security policy configuration controlling unit, permission of the user may be authenticated using the storage authentication window. The user is allowed to use the visualized window provided by the security policy configuration controlling unit to configure the security policy only after the authentication succeeds.

The storage detection apparatus provided in the embodiment of the present invention is placed in an operating system in kernel mode; after file information is intercepted and a security level of file content is determined, file content of a high security level is redirected to a storage area of high data storage security, and information such as a file directory information is still stored in a location specified by a user. In this way, the security level of the file content itself is determined and stored, which is transparent to the user, thereby implementing division of security levels for different documents generated by a same application.

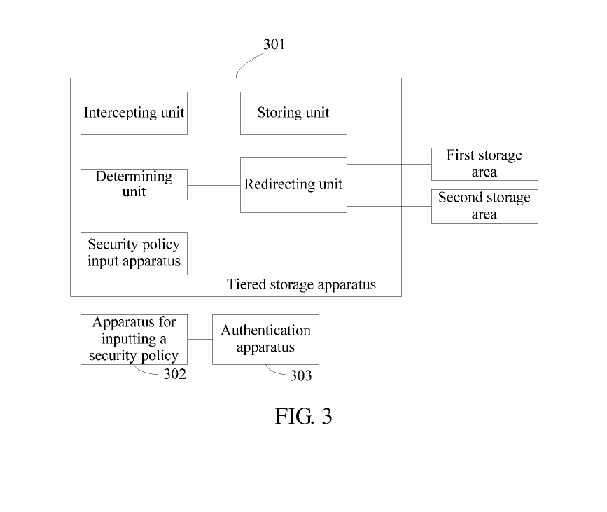

Referring to FIG. 3, an embodiment of the present invention further provides a storage detection system, including a storage detection apparatus 301 described in the foregoing embodiment and an apparatus for inputting a security policy 302.

Functionality of the storage detection apparatus 301 is the same as that of the foregoing storage detection apparatus.

The security policy input apparatus 302 is configured to, by providing a visualized application window for a user, receive a security policy input by the user, and send the received security policy to the storage detection apparatus 301.

Referring to FIG. 3, the security policy sent by the security policy input apparatus 302 is received by a security policy receiving unit of the storage detection apparatus 301.

To ensure that the user who inputs the security policy has permission to set the security policy, the storage detection system may further include an authentication apparatus 303, configured to authenticate the permission of the user before the security policy input apparatus 302 receives the security policy input by the user, and, after the authentication succeeds, start the security policy input apparatus 302; if the authentication fails, do not start the security policy input apparatus 302.

The storage detection system provided in the embodiment of the present invention stores documents separately according to security, and in addition, provides a visualized application window of a security policy, which enables a user to set the security policy of tiered storage flexibly; and, before the user sets the security policy, authenticates the user to ensure validity of input.

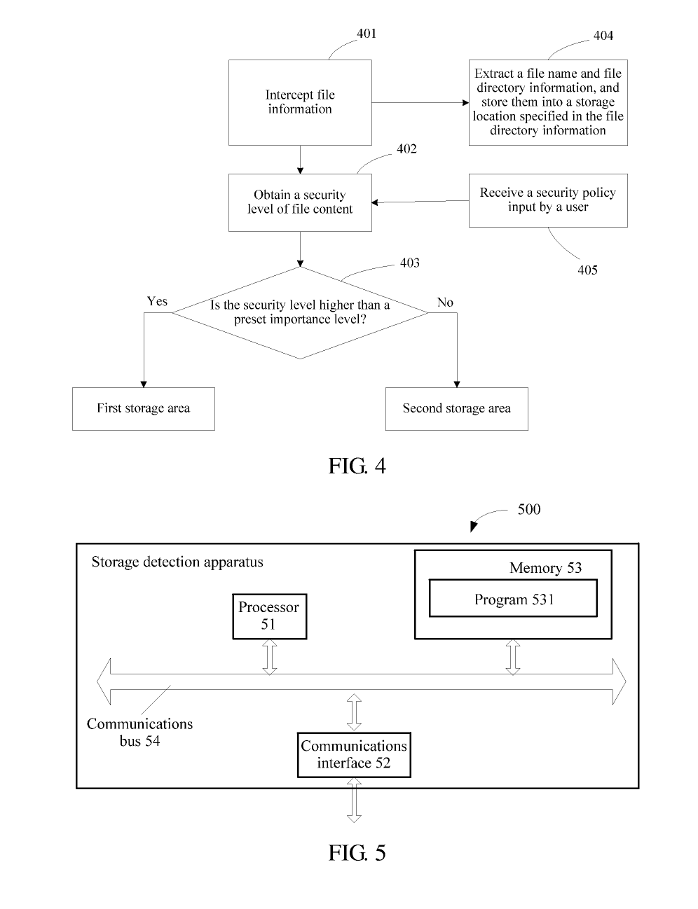

Referring to FIG. 4, corresponding to the apparatus provided in the embodiment of the present invention, an embodiment of the present invention provides a storage detection method, which is applied in an operating system in kernel mode. Detailed working principles of the method provided in the embodiment of the present invention are the same as those described in the foregoing apparatus embodiment, so only a procedure of the method is described herein. For details, reference may be made to the description in the foregoing apparatus embodiment.

The storage detection method provided in the embodiment of the present invention is applied in the operating system in kernel mode and includes the following steps.

Step 401: Intercept file information, where the intercepted file information includes file property information and file content, where the file property information includes file security information.

Optionally, an external interface driver in the operating system is invoked and the external interface driver is used to intercept the file information.

Step 402: Obtain a security level of the file content according to the file security information and based on a set security policy.

Step 403: If the obtained security level reaches a preset importance level, redirect the file content to a first storage area for storing; if the obtained security level does not reach the preset importance level, redirect the file content to a second storage area for storing, where data storage security of the second storage area is lower than data storage security of the first storage area.

Optionally, after intercepting the file information and determining the file security information, the storage detection method provided in the embodiment of the present invention performs redirected storage for the file content. In order not to change operation habits of the user, the redirection work is not perceivable by the user. Therefore, a file name, directory information, and the like in the file information need to be stored according to a location specified by the user. The file property information further includes file directory information and the file name; and therefore, the storage detection method provided in the embodiment of the present invention further includes the following step.

Step 404: Invoke a file driver in the operating system, and use the file driver to extract the file name and the file directory information from the obtained file information; and invoke a volume directory management system in the operating system, and use the volume directory management system to store the file name and the file directory information into a storage location specified in the file directory information.

Optionally, according to the storage detection method provided in the embodiment of the present invention, the preset security policy may be a default security policy that is set in a tiered storage, or may be set by the user flexibly according to actual requirements. Therefore, to support the storage work of the storage detection method provided in the embodiment of the present invention, some application programs may be further provided so that a visualized application window is provided for the user. Using the visualized application window, the preset security policy input by the user is received, and the received security policy is sent to the storage detection apparatus. Therefore, the storage detection method provided in the embodiment of the present invention may further include the following step.

Step 405: Receive the security policy input by the user, and use the received security policy to determine a security level of the file content.

The storage detection method provided in embodiment of the present invention is applied in an operating system in kernel mode; after file information is intercepted and a security level of file content is determined, file content of a high security level is redirected to a storage area of high storage security; the security level of the file content itself is determined and stored, which is transparent to a user, thereby implementing division of security levels for different documents generated by a same application.

Referring to FIG. 5, an embodiment of the present invention further provides a storage detection apparatus 500, where the apparatus is placed in an operating system in kernel mode and includes a processor 51, a memory 53, a communications interface 52, and a bus 54.

The processor 51, the communications interface 52, and the memory 53 communicate with each other using the bus 54.

The communications interface 52 is configured to communicate with an external interface driver, a file driver, and a volume directory management system in the operating system.

The processor is configured to execute a program 531.

The program 531 may include program code, where the program code includes computer operation instructions.

The memory 53 is configured to store the program 531.

After receiving an execution instruction, the program 531 implements the method described in the foregoing method embodiment. For detailed implementation, reference may be made to the method embodiment. Program units of the program 531 may include an intercepting unit 101, configured to intercept file information, where the intercepted file information includes file property information and file content, where the file property information includes file security information; a security level obtaining unit 102, configured to obtain a security level of the file content according to the file security information and based on a set security policy; and a redirecting unit 103, configured to, if the obtained security level reaches a preset importance level, redirect the file content to a first storage area for storing; if the obtained security level does not reach the preset importance level, redirect the file content to a second storage area for storing, where data storage security of the second storage area is lower than data storage security of the first storage area.

The program 531 may further include a storing unit 104, configured to invoke the file driver in the operating system, and use the file driver to extract the file name and the file directory information from the obtained file information; and invoke the volume directory management system in the operating system, and use the volume directory management system to store the file name and the file directory information into a storage location specified in the file directory information.

The program 531 may further include a security policy receiving unit 105, configured to receive the security policy, where the received security policy is provided for the security level obtaining unit 102 to determine the security level of the file content.

For specific implementation of each unit in the program 531, reference may be made to corresponding units in the embodiment shown in FIG. 1, and details are not described herein again.

The storage detection apparatus 500 provided in the embodiment of the present invention is placed in an operating system in kernel mode; after file information is intercepted and a security level of file content is determined, file content of a high security level is redirected to a storage area of high data storage security, and information such as a file directory is still stored in a location specified by a user. In this way, the security level of the file content itself is determined and stored, which is transparent to the user, thereby implementing division of security levels for different documents generated by a same application.

In the several embodiments provided in the present application, it should be understood that the disclosed system, apparatus, and method may be implemented in other manners. The described apparatus embodiment is merely exemplary. For example, the unit division is merely logical functionality division and may be other division in actual implementation. For example, a plurality of units or components may be combined or integrated into another system, or some features may be ignored or not performed. In addition, displayed or discussed mutual couplings or direct couplings or communication connections may be implemented through some communications interfaces, and indirect couplings or communication connections between the apparatuses or units may be electric, mechanical, or in other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functionality is implemented in a form of a software functional unit and sold or used as an independent product, the functionality may be stored in a computer-readable storage medium. Based on such an understanding, the technical solutions of the present invention essentially, or the part contributing to the prior art, or a part of the technical solutions may be implemented in a form of a software product. The software product is stored in a storage medium, and includes several instructions for instructing a computer device (which may be a personal computer, a server, a network device, or the like) to perform all or a part of the steps of the methods described in the embodiments of the present invention. The foregoing storage medium includes any medium that can store program code, such as a universal serial bus (USB) flash drive, a removable hard disk, a read-only memory (ROM), a random access memory (RAM), a magnetic disk, or an optical disc.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A storage detection method, wherein the method is applied in an operating system in kernel mode and comprises:
intercepting file information, wherein the intercepted file information comprises file property information and file content, wherein the file property information comprises file security information;
obtaining a security level of the file content according to the file security information and based on a set security policy;
redirecting the file content to a first storage area for storing when the obtained security level reaches a preset importance level; and
redirecting the file content to a second storage area for storing when the obtained security level does not reach the preset importance level.

2. The method according to claim 1, wherein intercepting the file information comprises:
invoking an external interface driver in the operating system; and
intercepting the file information using the external interface driver.

3. The method according to claim 1, wherein the file property information further comprises a file name and file directory information, and wherein the method further comprises:
invoking a file driver in the operating system;
using the file driver to extract the file name and the file directory information from the obtained file property information;
invoking a volume directory management system in the operating system; and
using the volume directory management system to store the file name and the file directory information into a storage location specified in the file directory information.

4. The method according to claim 1, wherein the file property information further comprises file directory information and a file name, wherein the operating system is a Windows operating system, and wherein the method further comprises:
invoking a file system new technology file system (NTFS) interface;
using the file system NTFS interface to extract the file name and the directory information from the file property information;
invoking a volume directory management system (VolMg) interface; and
using the VolMg interface to store the extracted file name and file directory information into a location specified in the file directory information.

5. The method according to claim 1 further comprising receiving the security policy, wherein the received security policy is used to determine the security level of the file content.

6. The method according to claim 1, wherein data storage security of the second storage area is lower than data storage security of the first storage area.

7. A storage detection apparatus, wherein the apparatus comprises:
a processor;
a memory;
a communications interface; and
a bus, wherein the processor, the communications interface, and the memory communicate with each other using the bus, wherein the communications interface is configured to communicate with an external interface driver, a file driver, and a volume directory management system in an operating system, wherein the memory is configured to store a program, and wherein the processor is configured to execute the program in an operating system in kernel mode in the memory, to implement the following steps:
intercepting file information, wherein the intercepted file information comprises file property information and file content, wherein the file property information comprises file security information;
obtaining a security level of the file content according to the file security information and based on a set security policy;
redirecting the file content to a first storage area for storing when the obtained security level reaches a preset importance level; and
redirecting the file content to a second storage area for storing when the obtained security level does not reach the preset importance level.

8. The apparatus according to claim 7, wherein the step of intercepting file information comprises:
invoking an external interface driver in the operating system; and
intercepting the file information using the external interface driver.

9. The apparatus according to claim 7, wherein the file property information further comprises a file name and file directory information, and wherein the processor further executes the following steps:
invoking a file driver in the operating system;
using the file driver to extract the file name and the file directory information from the obtained file property information;
invoking a volume directory management system in the operating system; and
using the volume directory management system to store the file name and the file directory information into a storage location specified in the file directory information.

10. The apparatus according to claim 7, wherein the file property information further comprises file directory information and a file name, wherein the operating system is a Windows operating system, and wherein the processor further executes the following steps:
invoking a file system new technology file system (NTFS) interface;
using the file system NTFS interface to extract the file name and the directory information from the file property information;
invoking a volume directory management system (VolMg) interface; and
using the VolMg interface to store the extracted file name and file directory information into a location specified in the file directory information.

11. The apparatus according to claim 7, wherein the processor further executes the step of receiving the security policy, wherein the received security policy is used to determine the security level of the file content.

12. The apparatus according to claim 7, wherein data storage security of the second storage area is lower than data storage security of the first storage area.

13. A storage detection system comprising:
an apparatus for inputting a security policy; and
a storage detection apparatus, wherein the apparatus comprises:
a processor;
a memory;
a communications interface; and
a bus, wherein the processor, the communications interface, and the memory communicate with each other using the bus, wherein the communications interface is configured to communicate with an external interface driver, a file driver, and a volume directory management system in an operating system, wherein the memory is configured to store a program, and wherein the processor is configured to execute the program in an operating system in kernel mode in the memory to implement the following steps:
intercepting file information, wherein the intercepted file information comprises file property information and file content, wherein the file property information comprises file security information;
obtaining a security level of the file content according to the file security information and based on a set security policy;
redirecting the file content to a first storage area for storing when the obtained security level reaches a preset importance level; and
redirecting the file content to a second storage area for storing when the obtained security level does not reach the preset importance level, wherein the security policy input apparatus is configured to receive the security policy input by a user, and send the received security policy to the storage detection apparatus.

14. The system according to claim 13, wherein intercepting the file information comprises:
invoking an external interface driver in the operating system; and
intercepting the file information using the external interface driver.

15. The system according to claim 13, wherein the file property information further comprises a file name and file directory information, and wherein the processor further executes the following steps:
invoking a file driver in the operating system;
using the file driver to extract the file name and the file directory information from the obtained file property information;
invoking a volume directory management system in the operating system; and
using the volume directory management system to store the file name and the file directory information into a storage location specified in the file directory information.

16. The system according to claim 13, wherein the file property information further comprises file directory information and a file name, wherein the operating system is a Windows operating system, and wherein the processor further executes the following steps:
invoking a file system new technology file system (NTFS) interface;
using the file system NTFS interface to extract the file name and the directory information from the file property information;
invoking a volume directory management system (VolMg) interface; and
using the VolMg interface to store the extracted file name and file directory information into a location specified in the file directory information.

17. The system according to claim 13, wherein the processor further executes the step of receiving the security policy, wherein the received security policy is used to determine the security level of the file content.

18. The system according to claim 13, wherein data storage security of the second storage area is lower than data storage security of the first storage area.
